(19) United States
(12) Patent Application Publication
(10) Pub. No.: US 2011/0260988 A1
(43) Pub. Date: Oct. 27, 2011

(54) Method and apparatus for increasing magnitude and frequency of forces applied to a bare finger on a haptic surface

(75) Inventors: James Edward Colgate, Evanston, IL (US); Michael Peshkin, Evanston, IL (US); Erik Chubb, San Francisco, CA (US)

(73) Assignee: Northwestern University

(21) Appl. No.: 12/930,790

(22) Filed: Jan. 18, 2011

Related U.S. Application Data
(60) Provisional application No. 61/336,348, filed on Jan. 20, 2010.

(51) Int. Cl. G08B 6/00; G06F 3/041

(52) U.S. Cl. 345/173

(57) ABSTRACT

A haptic device capable of providing a force on a finger or object in contact with a substrate surface includes a substrate having a touch surface, includes a substrate having a touch surface, at least one first actuator for subjecting the substrate to out-of-plane ultrasonic oscillations controlled to provide relatively low and high friction states of the touch surface and at least one second actuator for subjecting the substrate to lateral oscillations while the substrate is alternated between the low and high friction states in a manner to generate a force felt by a user's finger on the touch surface. A control device provides signals to the at least one first actuator to establish relatively low and high friction states of the touch surface. An electrical damping circuit between the control device and the at least one first actuator is implemented for reducing the transition time between the low and high friction states. Reduction of the transition time increases forces felt by a user's finger on the touch surface.

This application claims priority and benefits of U.S. provisional application Ser. No. 61/336,348 filed Jan. 20, 2010, the disclosure of which is incorporated herein by reference.

### CONTRACTUAL ORIGIN OF THE INVENTION

This invention was made with government support under Grant No. IIS-0413204 awarded by the National Science Foundation. The Government has certain rights in the invention.

### FIELD OF THE INVENTION

The present invention relates to a haptic device that can provide a shear force on a user's finger or an object on the surface of the device.

### BACKGROUND OF THE INVENTION

Copending U.S. patent application Ser. No. 11/726,391 filed Mar. 21, 2007, of common assignee discloses a haptic device having a tactile interface based on modulating the surface friction of a substrate, such as glass plate, using ultrasonic vibrations. The device can provide indirect haptic feedback and virtual texture sensations to a user by modulation of the surface friction in response to one or more sensed parameters and/or in response to time (i.e. independent of finger position). A user actively exploring the surface of the device can experience the haptic illusion of textures and surface features. Copending U.S. patent application Ser. No. 12/383,120 filed Mar. 19, 2009, describes a haptic device having a tactile interface comprising a plurality of surface regions where surface friction is modulated using ultrasonic vibrations.

This haptic device is resistive in that it can only vary the forces resisting finger motion on the interface surface, but it cannot, for instance, re-direct finger motion.

It would be desirable to provide the variable friction benefits of this haptic device and also to provide shear forces to a user's finger or an object on the interface surface of the glass plate substrate.

Copending U.S. patent application Ser. No. 12/589,178 filed Oct. 19, 2009, describes a haptic device (SwirlPad) capable of providing a force on a finger or object in contact with a substrate touch surface by subjecting a haptic device to in-plane lateral motion (lateral oscillation) while alternating the substrate between low and high friction states within each cycle. In order to achieve high in-plane frequencies, the haptic device must transition quickly between high and low friction states. However, the out-of-plane oscillation at for example 39 kHz takes significant time to decay. During this decay time, the low friction state may continue to be produced by the continuing unforced oscillation even though the piezoelectric or other actuator is not being energized.

### SUMMARY OF THE INVENTION

The present invention provides a haptic device capable of providing a force on a finger or object in contact with a substrate surface. In one embodiment of the invention, the haptic device comprises a substrate having a touch surface, at least one first actuator (e.g. piezoelectric actuator) for subjecting the substrate to friction reducing ultrasonic oscillations controlled to provide relatively low and relatively high friction states of the touch surface, and at least one second actuator (e.g. voice coil) for subjecting the substrate to lateral oscillations while the substrate is alternated between low and high friction states to generate a force felt by the user's finger on the touch surface. A control device (e.g. a signal generator) is provided for sending signals to the at least one first actuator to establish the relatively low and high friction states of the touch surface. At least one electrical damping circuit is provided for damping the friction-reducing oscillations between low and high friction states, thereby reducing the transition time (decay time) between the low and high friction states. Reduction of the transition time between low and high friction states increases forces felt by a user's finger on the touch surface.

In an illustrative embodiment of the invention, the electrical damping circuit comprises at least one resistor-inductor circuit disposed in parallel between electrical conductors between the control device and the at least one first actuator. The resistor-inductor circuit is connected in the main control circuit between low and high friction states to damp out out-of-plane oscillations to thereby reduce the transition time and is disconnected when the out-of-plane oscillations are desired. The relay is controlled by a programmable integrated circuit that also actuates/deactuates the control device.

In a particular illustrative embodiment, the invention provides a haptic device comprising a flat substrate having a touch surface, a flat piezoelectric actuator laminated to the flat substrate for subjecting the substrate to friction reducing, out-of-plane ultrasonic oscillations to provide a relatively low friction state when the piezoelectric actuator is energized wherein the substrate is in a relatively high friction state when the piezoelectric actuator is not energized, and another actuator for subjecting the substrate to in-plane lateral oscillations while the substrate is alternated between the low and high friction states. The control device provides waveform signals to the piezoelectric actuator to energize it to ultrasonically oscillate the substrate out-of-plane to provide the relatively low friction state. A resistor-inductor damping circuit in parallel between electrical conductors between the control device and the piezoelectric actuator damps out-of-plane oscillations and reduces the transition time between the low and high friction states when the piezoelectric actuator is de-energized. A solid state relay connects the resistor-inductor damping circuit in the main control circuit to reduce transition time when the piezoelectric actuator is de-energized and disconnects the resistor-inductor damping circuit when the piezoelectric actuator is energized.

In another illustrative embodiment of the invention, the electrical damping circuit comprises a feedback circuit comprising a sensing piezoelectric element disposed on the haptic device. The output signal of the sensing piezoelectric element is fed back to a feedback controller that when needed, outputs a damping command, which is based on a proportional, proportional plus derivative, or proportional plus integral plus derivative signal processing, to the piezoelectric actuator to damp out out-of-plane oscillations between low and high friction states, thereby reducing the transition time (decay time) between the low and high friction states.

The present invention also envisions a method of controlling a haptic device having a substrate with a touch surface by subjecting the substrate to friction reducing, out-of-plane ultrasonic oscillations controlled to provide low and high friction states of the touch surface, subjecting the substrate to lateral in-plane oscillations while the substrate is alternated between the low and high friction states in a manner to generate a force felt by a user's finger on the touch surface, and electrically damping unforced substrate friction-reducing oscillations to reduce the transition time between the low and high friction states when the ultrasonic oscillation are terminated. The reduction of the transition time between the low and high friction states increases forces felt on the touch surface by a user. The method of the invention can provide a force on the user's finger wherein the force has is non-zero average and in which the non-zero average force can be sustained indefinitely.

Advantages of the present invention will become more readily apparent from the following detailed description taken with the following drawings.

### BRIEF DESCRIPTION OF THE DRAWINGS

FIG. 1A is a perspective view of a haptic device TPaD capable of variable friction effect. FIG. 1B is a perspective view of a mount for the haptic device TPaD.

FIG. 2 is a perspective view of the haptic device TPaD adhered in the mount.

FIG. 3 is a schematic perspective view of a planar haptic device including the haptic device TPaD and other components pursuant to the invention.

FIG. 4 is a schematic view of a control system for controlling the actuators in a manner to subject the substrate to lateral oscillation in synchrony with the friction reducing oscillation to create a shear force on the user's finger or an object in contact with the substrate. FIG. 4 schematically shows an electrical damping circuit pursuant to an embodiment of the invention

FIG. 5 is a schematic view of a finger position sensor system for use in practicing an embodiment of the invention.

FIG. 6A is a schematic view showing rightward movement of the TPaD with high friction to create a rightward impulse on the finger. FIG. 6B is a schematic view showing leftward movement of the TPaD with low friction to prepare for a another rightward impulse.

FIG. 7 is a schematic diagram of an electrical damping circuit pursuant to an illustrative embodiment of the invention wherein the damping circuit comprises a resistor-inductor circuit connected between the electrical lead lines to the piezoelectric actuator.

FIGS. 8A, 8B, and 8C are plots showing the effect of the electrical damping circuit on the unforced ultrasonic Tpad oscillations. The unforced oscillations are damped by the “resistor only” circuit, FIG. 8B, and even morely heavily damped by the resistor-inductor (R-L) circuit, FIG. 8C. FIG. 8A shows the unforced oscillations in the absence of the damping circuit.

FIG. 9 is a diagram of an electrical damping feedback circuit pursuant to another embodiment of the invention.

### DETAILED DESCRIPTION OF THE INVENTION

The present invention provides a haptic device referred to as a surface haptic device (SHD) capable of providing a force on a finger or object in contact with a haptic substrate surface by subjecting the substrate to lateral motion or lateral oscillation and modulation of a friction reducing out-of-plane oscillations wherein the magnitude and frequency of forces applied to a finger of a user of the haptic device are increased by reduction in the transition time between a low friction state and an high friction state of the touch surface pursuant to the invention. Actuators connected to the haptic substrate are controlled by a computer control device to subject the substrate to lateral motion or lateral oscillation in synchrony with modulation of the friction reducing out-of-plane oscillations in a manner to create a shear force on the user's finger or an object in contact with the substrate surface as described for a so-called variable friction haptic device designated as TPaD (“Tactile Pattern Display”) haptic device in copending application Ser. No. 12/589,178 filed Oct. 19, 2009, the teachings of which are incorporated herein by reference.

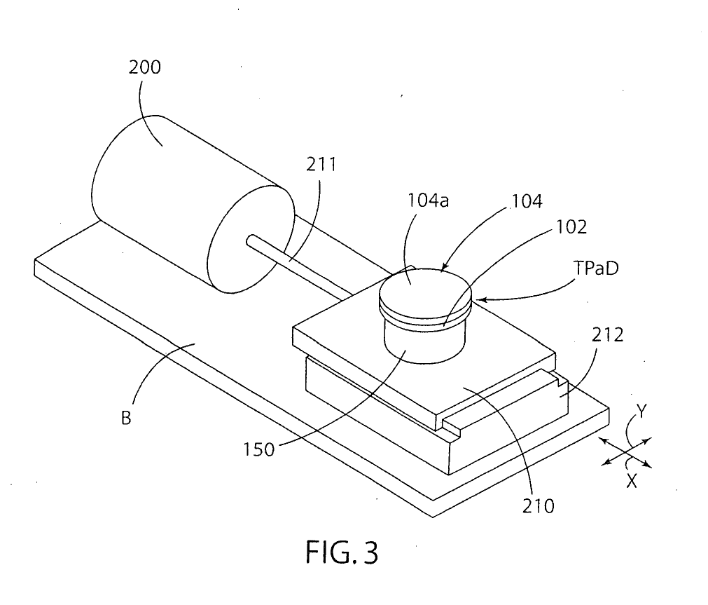

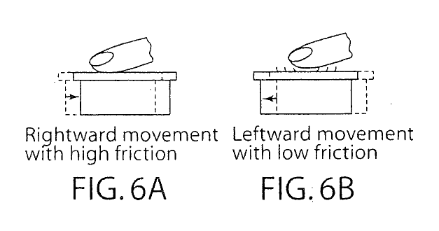

In such a TPaD haptic device, the haptic substrate 100 is subjected to in-plane lateral motion or oscillation on a single axis (e.g. X axis) or on multiple (e.g. X and Y axes) axes together with friction-reducing out-of-plane oscillations. In the one degree-of-freedom embodiment, FIG. 3, forces are created by alternating between low and high friction states at the same frequency that the haptic device TPaD is being oscillated laterally in-plane. To produce a net leftward force, the haptic device TPaD s set to high friction while its velocity is leftward and set to low friction when its velocity is rightward. The haptic device TPaD alternates between pushing the user's finger to the left and slipping underneath the finger back to the right. This “pushslip” cycle repeats itself, and the series of strong leftward impulses followed by weak rightward impulses results in a net force to the left. FIGS. 6A, 6B illustrate a “push slip” cycle to generate the opposite net force to the right wherein strong rightward impulses are followed by weak leftward impulses resulting in a net force to the right on a user's finger. The invention thus can provide a force on the user's finger wherein the force has a non-zero average and in which the non-zero average force can be sustained indefinitely by controlled substrate oscillations as described. In some operational modes of the haptic device, friction level of the touch surface can be modulated smoothly up and down in synchrony with the in-plane motion.

By changing the phase angle between the lateral velocity and the haptic device TPaD on/off signal, the direction and magnitude of the net force can be changed. For explanation, the term φₒₙ is defined as the phase angle of the lateral velocity when the haptic device TPaD turns on (low friction state on) as described in copending application Ser. No. 12/589,178 filed Oct. 19, 2009. One skilled in the art will recognize that force can be controlled not just by phasing, but also by modulating the amount of time that the TPaD substrate is in the relatively high friction state. Force may be reduced by reducing the amount of a cycle for which friction is high. Moreover, it has been found experimentally that as the amplitude of lateral displacement increases, the average net force increases proportionally at first and then saturates.

The present invention will be described herebelow in connection with a one-degree-of-freedom TPaD haptic device for purposes of illustration, but the present invention is not so limited and can be practiced in connection with a variety of one or more degree-of-freedom haptic devices that create a net force on a user's finger using substrate in-plane motion or oscillation together with substrate out-of-plane oscillation to provide modulated touch surface friction.

### TPaD Haptic Device

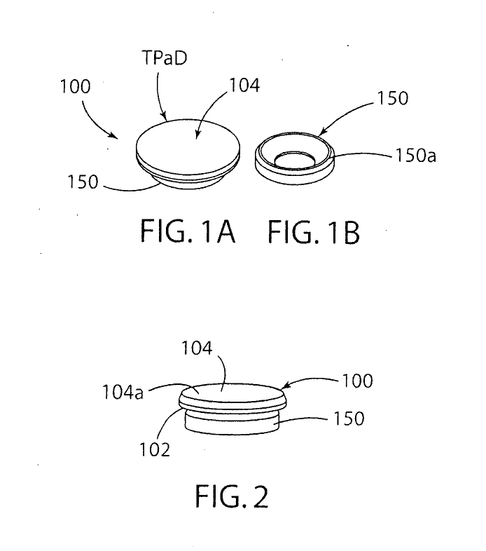

An illustrative embodiment of the present invention employs theTPaD (“Tactile Pattern Display”) haptic device shown in FIGS. 1A, 1B and 2 and described in copending application Ser. No. 12/589,178 filed Oct. 19, 2009, as having a substrate 100 that comprises a piezoelectric bending element 102 in the form of piezoelectric sheet or layer member attached to a passive substrate sheet or layer member 104 with a touch (haptic) surface 104a to provide a relatively thin laminate structure and thus a slim haptic device design that can provide advantages of slimness, high surface friction, inaudiblity and controllable friction. A relatively thin haptic device can be made of a piezo-ceramic sheet or layer glued or otherwise attached to a passive support sheet or layer 104. When voltage is applied across the piezoelectric sheet or layer 102, it attempts to expand or contract, but due to its bond with the passive support sheet or layer 104, cannot. The laminate will have a curved shape with a single peak or valley in the center of the disk when the piezoelectric sheet or layer 102 is energized. The resulting stresses cause bending. The greater the voltage applied to the piezoelectric sheet or layer, the larger the deflection. When the piezoelectric bending element is excited by a positive excitation voltage, it bends with upward/positive curvature. When the piezoelectric bending element is excited by a negative excitation voltage, it bends with a downward/negative curvature. When sinewave (sinusoidal) excitation voltage is applied, the piezoelectric bending element will alternately bend between these curvatures. When the sinewave excitation voltage is matched in frequency to the resonant frequency of the substrate 100, the amplitude of oscillation is maximized. A mount 150 may be used to confine the bending to only one desired mode or to any number of desired modes. It is preferred that all mechanical parts of the haptic device vibrate outside of the audible range. To this end, the substrate 100 preferably is designed to oscillate at resonance above 20 kHz.

For purposes of illustration and not limitation, a thickness of the piezoelectric member 102 can be about 0.01 inch to about 0.125 inch. An illustrative thickness of the substrate member 104 can be about 0.01 to about 0.125 inch. The aggregate thickness of the haptic device thus can be controlled so as not exceed about 0.25 inch in an illustrative embodiment of the invention.

As shown in FIGS. 1A, 1B and 2, the disk-shaped haptic device is disposed in a mount 150 in order to confine the vibrations of the bending element disk to the 01 mode where the 01 mode means that the laminate has a curvature with a single peak or valley in the center of the disk when the piezoelectric sheet or layer is excited. The mount 150 can be attached to the piezoelectric disk along a thin ring or annular surface 150a whose diameter can be ⅔ of the diameter of the piezoelectric disk. The same very low viscosity epoxy adhesive can be used for the bond to the mount 150 as used to bond the piezoelectric disk and the glass substrate disk. The inner height of the mount 150 is somewhat arbitrary and can also be made as thin as a few millimeters. The mount 150 is adapted to be mounted on or in an end-use product such as including, but not limited to, on or in a surface of an motor vehicle console, dashboard, steering wheel, door, computer, and other end-use applications/products.

A transparent haptic device preferably is provided when the haptic device is disposed on a touchscreen, on a visual display, or on an interior or exterior surface of a motor vehicle where the presence of the haptic device is to be disguised to blend with a surrounding surface so as not be readily seen by the casual observer. To this end, either or both of the piezoelectric member 102 and the substrate member 104 may be made of transparent material. The piezoelectric element 102 includes respective transparent electrodes (not shown) on opposite sides thereof for energizing the piezoelectric member 102.

For purposes of illustration and not limitation, the substrate 104 may be glass or other transparent material. For the electrode material, thin films of the In₂O₃—SnO₂ indium tin oxide system may be used as described in Kumade et al., U.S. Pat. No. 4,352,961 to provide transparent electrodes. It is not necessary to employ transparent piezoelectric material in order to achieve a transparent haptic device. It will be appreciated that passive substrate sheet 104 may be made of a transparent material such as glass, and that it may be significantly larger in surface area than piezoelectric sheet 102. Piezoelectric sheet 102 may occupy only a small area at the periphery of passive substrate sheet 104, enabling the rest of passive substrate sheet 104 to be placed over a graphical display without obscuring the display. The piezoelectric material can include, but is not limited to, PZT (Pb(Zr, Ti)O₃)-based ceramics such as lanthanum-doped zirconium titanate (PLZT), (PbBa)(Zr, Ti)O₃, (PbSr)(ZrTi)O₃ and (PbCa)(ZrTi)O₃, barium titanate, quartz, or an organic material such as polyvinylidene fluoride.

Those skilled in the art will appreciate that the invention is not limited to transparent piezoelectric and substrate members and can be practiced using translucent or opaque ones, which can be colored as desired for a given service application where a colored haptic device is desired for cosmetic, security, or safety reasons. Non-transparent materials that can be used to fabricate the substrate member 104 include, but are not limited to, steel, aluminum, brass, acrylic, polycarbonate, and aluminum oxide, as well as other metals, plastics and ceramics.

Those skilled in the art will also appreciate that bending vibration of the substrate member may be created by other types of actuators besides piezoelectric actuators. For instance, electrostatic, electromagnetic and magnetostrictive actuators may all be used. Those skilled in the art will further appreciate that in-plane vibration of the substrate member may be created by various other types of actuators including piezoelectric, electrostatic, electromagnetic and magnetostrictive actuators may all be used.

Design of a circular disk-shaped haptic device TPaD will include choosing an appropriate disk radius, piezo-ceramic disk thickness, and substrate disk material and thickness. The particular selection made will determine the resonant frequency of the device. A preferred embodiment of a disk-shaped haptic device employs a substrate disk having a thickness in the range of 0.5 mm to 2 mm and made of glass, rather than steel or other metal, to give an increase in resonant frequency (insuring operation outside the audible range) without significantly sacrificing relative amplitude.

Those skilled in the art will appreciate that the design of the piezoelectric bending element 102 and substrate 104 are not constrained to the circular disk shape described. Other shapes, such as rectangular or other polygonal shapes can used for these components as will be described below and will exhibit a different relative amplitude and resonant frequency.

With respect to the illustrative disk-shaped haptic device TPaD of FIGS. 1A, 1B and 2, the amount of friction felt by the user on the touch (haptic) surface 104a of the haptic device is a function of the amplitude of the excitation voltage at the piezoelectric member 102. The excitation voltage is controlled as described in the Example below and also in copending U.S. application Ser. No. 11/726,391 filed Mar. 21, 2007, and copending U.S. application Ser. No. 12/383,120 filed Mar. 19, 2009, which are incorporated herein by reference. The excitation voltage is an amplitude-modulated periodic waveform preferably with a frequency of oscillation substantially equal to a resonant frequency of the haptic device. The control system can be used with pantograph/optical encoders or with the optical planar (two dimensional) positioning sensing system or with any other single-axis or with two-axis finger position sensors which are described in copending application Ser. No. 11/726,391 incorporated herein by reference, or with any other kind of finger position sensor, many of which are known in the art.

The following COMPARATIVE EXAMPLE and EXAMPLE OF THE INVENTION describe TPaD haptic device having one degree-of-freedom (x axis motion) without and with electrical damping pursuant to the invention, respectively. Two degree-of freedom haptic devices are described in copending application Ser. No. 12/589,178 filed Oct. 19, 2009, which is incorporated herein by reference, and can benefit from practice of the present invention as well.

### Comparative Example

### One Degree of Freedom Planar Haptic Device without Damping of Out-of-Plane Oscillations

Referring to FIG. 3, an illustrative planar surface haptic device SHD is shown incorporating the disk-shaped haptic device TPaD of FIGS. 1A, 1B and 2 hereafter referred to as TPaD. At the heart of the variable friction haptic device of this Comparative Example is the TPaD device that modulates the friction of the glass surface 104a by using 39 kHz out-of-plane vibrations to form a squeeze film of air between the finger and the glass. The squeeze film reduces the friction level. The 39 kHz resonant vibration of the TPaD device is induced by the piezoelectric element 102. To generate shear forces, the TPaD is oscillated in-plane while alternating between low and high friction within each cycle.

The disk-shaped haptic device TPaD was constructed using a single circular disk of piezoelectric bending element (Mono-morph Type) and a single circular disk of glass plate substrate to generate the ultrasonic frequency and amplitude necessary to achieve the indirect haptic effect of friction reduction. The piezoelectric bending element disk comprised PIC151 piezo-ceramic material (manufactured by PI Ceramic, GmbH) having a thickness of one (1) millimeter and diameter of 25 millimeters (mm). The glass plate substrate disk comprised a thickness of 1.57 mm and a diameter of 25 mm. The piezo-ceramic disk was bonded to the glass substrate disk using a very low viscosity epoxy adhesive such as Loctite E-30CL Hysol epoxy adhesive. The disk-shaped haptic device was disposed in a mount made of aluminum and attached to the piezoelectric disk along a thin ring or annular surface 150a whose diameter was ⅔ of the diameter of the piezoelectric disk. The same very low viscosity epoxy adhesive was used for the bond to the mount 150 as was used to bond the piezoelectric disk and the glass substrate disk.

The haptic device SHD further includes a linear actuator 200, such as a voice coil, connected by coupling rod 211 to a linear slider 210 on which the haptic device TPaD fixedly resides for movement therewith. The TPaD can be held in fixed position on the slider 210 by any connection means such as a clamp, glue, screws, or rivets. The linear slider 210 is movably disposed on support 212 on a fixed base B for movement on a single X axis. A linear voice coil actuator 200 is sinusoidally activated at frequencies between 20 and 1000 Hz, causing the slider 210 and haptic device TPaD thereon to move oscillate laterally in the X-direction (in-plane) at the same frequency. When voice coil actuator 200 is sinusoidally activated at the resonant frequency of this system, the amplitude of lateral oscillations is increased although the invention is not limited to such sinusoidal activation. An in-plane frequency of less than 100 Hz produces good operating results.

One skilled in the art will recognize that actuators other than a voice coil can be used to generate in-plane vibrations. Piezoelectric, electrostatic, magnetostrictive, and other types of electromagnetic actuators, such as Linear Resonant Actuators, may also be used.

Friction is modulated on the glass plate substrate surface 104a of the haptic device TPaD by applying a 39 kHz sinusoid to the piezoelectric element 102 mounted on the underside of the glass plate substrate 104. The 39 kHz signal is generated by a AD9833 waveform generator chip and amplified to +0-20V using an audio amplifier. When applied to the piezoelectric element 102, it causes resonant vibrations of the glass plate substrate. These vibrations produce a squeeze film of air underneath the fingertip, leading to a reduction of friction. At high excitation voltages, the friction between the glass plate substrate and a finger is approximately μ=0.15, while at zero voltage, the surface has the friction of normal glass (approximately μ=0.95).

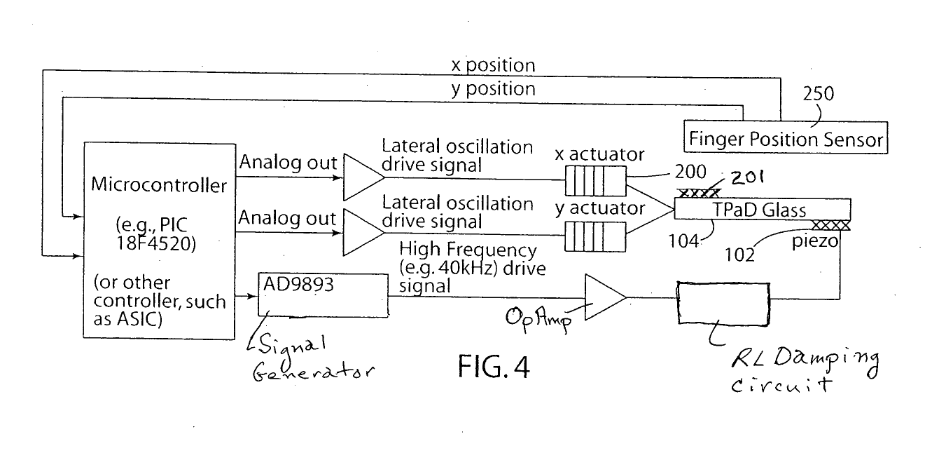

A programmable integrated circuit (PIC-18F4520) generates the low frequency signal for the voice coil (x-actuator) and issues the command to the wave form signal generator (AD98330), FIG. 4, which comprises the actuator (piezoelectric) control device to start/stop the 39 kHz signal of the piezoelectric element 102. Since it provides both functions, it can dictate the phase relationship between the friction level of the haptic device TPaD and the lateral motion. A control system or circuit having a microcontroller with the PIC or other controller and finger position sensor 250 is shown in FIG. 4. FIG. 4 shows an X axis-actuator to oscillate the linear slider 210 on the X-axis and also a Y axis-actuator for use with a two degree-of-freedom planar haptic device described below where the TPaD is oscillated on the X-axis and Y-axis concurrently.

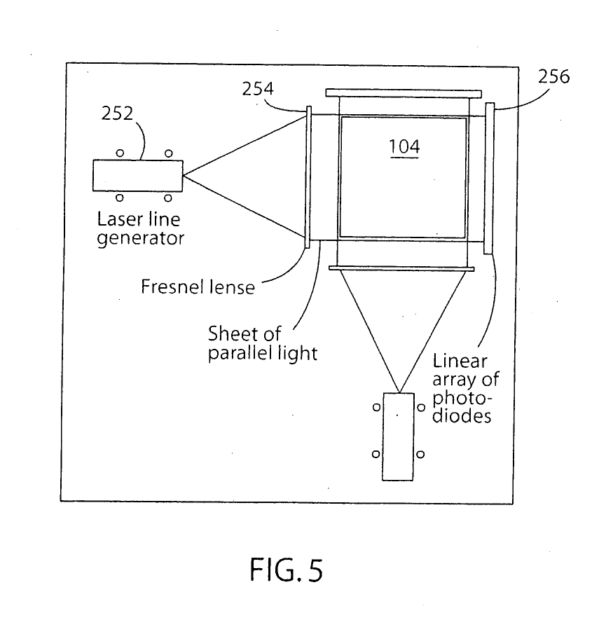

To measure finger position, a single axis of the two-axis finger positioning system 250 can be used. This system is of a type similar to the two-axis finger position sensors which are described in copending U.S. application Ser. No. 11/726,391, however the infrared light emitting diodes of that system have been replaced with laser line generators 252 and Fresnel lenses 254 which produce a collimated sheet of light striking linear photo diode array 256, FIG. 5. The collimated sheet of light is placed immediately above the surface 104a of the TPaD and a finger touching the TPaD surface 104a interrupts that sheet of light, casting a shadow on linear photo diode array 256. A PIC microcontroller reads the output of the linear photo diode array 256 and computes the centroid of the finger's shadow, which is used as a measure of finger position.

In this Comparative Example, use of in-plane frequencies of less than 100 Hz creates the intended forces on the user's finger but also creates a strong sensation of vibration to the user. That is, the user is aware of not only the overall force in one direction, but also the undesirable underlying vibration of the TPaD since the human fingertip is sensitive to vibrations in the range of 20 Hz to about 500 Hz, with a peak in sensitivity at about 250 Hz.

The present invention seeks to reduce this vibration artifact by using higher in-plane frequencies above 300 Hz such as approaching 1 kHz where human sensitivity to vibration is reduced, while providing a passive damping circuit to reduce transition time between the low and high friction states.

### Example of the Invention

To achieve such high in-plane frequencies such as approaching 1 kHz, the TPaD device must quickly transition between low and high friction states. However, in the Comparative Example above, it takes significant time for the TPaD's 39 kHz out-of-plane oscillation to decay. During this decay, a squeeze film may continue to be produced by the continuing unforced oscillations of the substrate 104 even though zero voltage is applied across the piezoelectric actuator 102. Moreover, as the in-plane vibration frequency is increased, the TPaD device moves in one direction for only a very short time before changing directions. For purposes of illustration and not limitation, if the in-plane (shiver) frequency is increased to 854 kHz, the TPaD device moves in one direction for only 0.59 ms before reversing directions. Therefore, in order to generate force, the TPaD device must be capable of alternating between low and high friction states in well under 0.59 ms.

The present invention provides at least one electrical damping circuit to damp out unforced out-of-plane oscillations of the substrate 104 during the ring-down period (decay period of the unforced oscillations). The damping circuit is rendered operative only during the times damping is required. Practice of the present invention enables significant reduction of the ring-down period (decay or transition period between low and high friction states), while leaving the haptic device control system otherwise unaffected. The reduction in ring-down improves the transition from low to high friction without affecting the amplitude or energy consumption during the low friction phase. Moreover, reduction of the transition time between low and high friction states increases forces felt by a user's finger on the touch surface. Practice of the present invention permit an increase of the in-plane frequency to a point where the human perception of vibrations is significantly reduced. If the TPaD substrate has several out-of-plane vibrational modes, the invention envisions providing a respective resistor-inductor circuit to control damping of each mode. Thus, one or more resistor-inductor damping circuits may be used in practice of the invention.

For purposes of illustration and not limitation, to achieve high shiver (lateral) frequencies, the TPaD device must quickly transition between high and low friction states. If the TPaD device has quality factor, Q, of about 35, meaning that about 35 cycles are needed for the out-of-plane vibration to decay. Thus, at the TPaD's frequency (39 kHz), it takes over 0.5 ms for the decay of vibrations to occur. During this decay, a squeeze film may continue to be produced by the continuing unforced oscillations even though zero voltage is applied across the piezo.

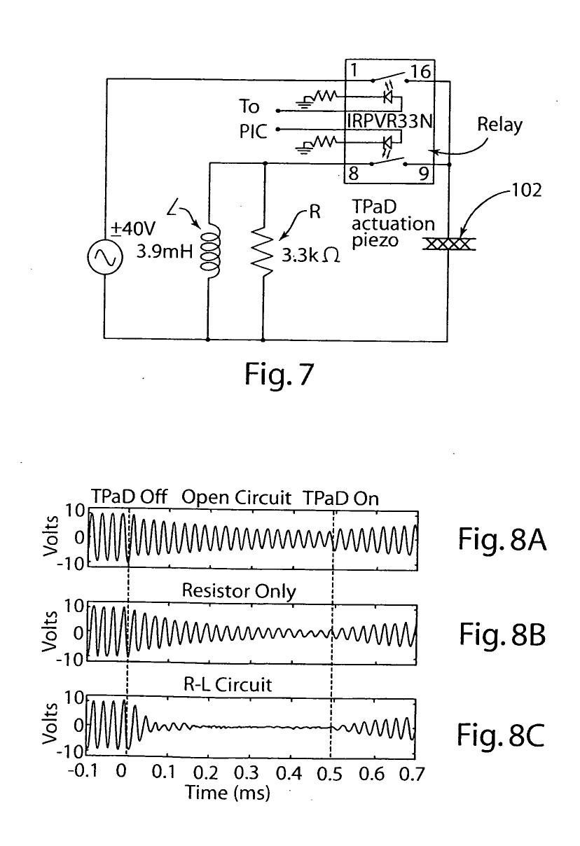

To reduce decay times in a TPaD prototype device, the circuit in FIG. 7 was implemented. By intermittently connecting the passive inductor-resistor network, applicants are able to significantly reduce the effective Q during the ring-down period, while leaving Q unreduced otherwise. The reduction in Q improves the rate of transition from low to high friction states, without affecting the amplitude or energy consumption during the low friction phase.

In particular, in FIG. 7, the TPaD control PIC is used to control the state of the two relays within the IRPVR33N solid state relay chip. When the upper relay is closed, the piezo is being actuated by the AC supply and the lower relay is opened to prevent the RL network from absorbing energy. When the upper relay is open, the lower relay is closed to introduce the RL network and damp out the TPaD's out-of-plane vibrations.

To determine the efficacy of the inductor-resistor network, tests were conducted on three different control circuits:

(1) In the Open Circuit (or baseline) condition, the RL network is not included in the circuit shown in FIG. 7. This results in the actuating piezoelectric element 102 being in the open-circuit condition when the TPaD is requested off
(2) In the Resistor Only condition, the inductor is omitted from the circuit in FIG. 7 leaving only the resistor as a damping element. The value of the resistance in this experiment is optimized to provide the maximum possible damping.
(3) In the RL Circuit condition, the circuit in FIG. 7 is implemented as shown. Both the inductance and resistance values are optimized to provide the maximum damping.

An analytical method of estimating the optimum values of the resistance and inductance is given in reference [12]. This yields the following theoretically optimum values:

R=sqrt(4KM/(8Cp*K*n̂2−n̂4))

L=2M/(2*Cp*K-n̂2)

Where M is the equivalent mass of the TPaD in the resonant mode of interest, K is the equivalent stiffness of the TPaD in the resonant mode of interest, n is a transformer ratio that relates voltage on the piezoelectric actuator to force acting on M and K, and Cp is the capacitance of the piezoelectric actuator.

In practice, good results are obtained if the inductance is selected so that the natural frequency of a circuit including the inductance and Cp matches the natural frequency of the out-of-plane vibration mode that we wish to damp out. The resistance value can then be adjusted (e.g., using a potentiometer) until the rate of decay is maximized.

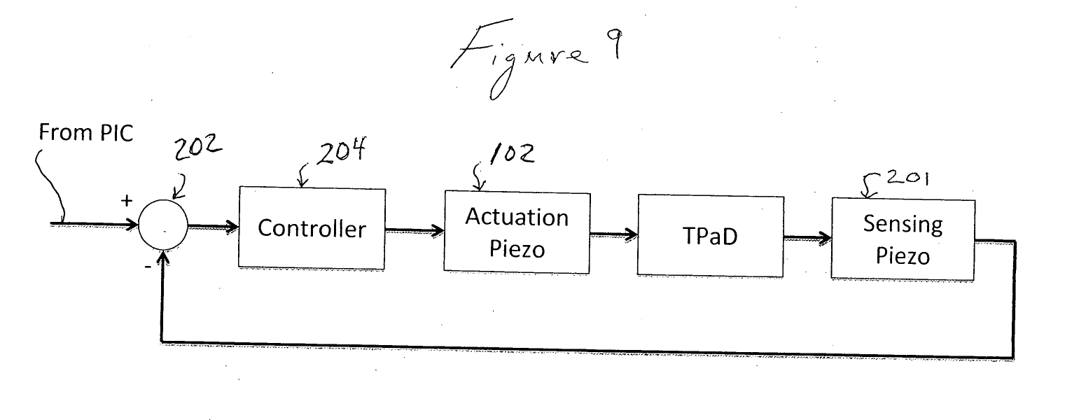

The plots in FIG. 8A, 8B, 8C demonstrate how the different damping methods affect the decay of the TPaD out-of plane oscillations. The amplitude data is the voltage observed by a second, smaller piezoelectric element used exclusively for post-process analysis. The exact calibration between displacement and voltage is unknown, but from the piezoelectric constitutive equations, it is known that the voltage output of the piezo is proportional to the displacement of the TPaD. This data comprises a little less than a full in-plane cycle (854 Hz vibration in the x-direction, but it possible to see one instance of the TPaD turning on and one instance of it turning off—these time points are indicated. The value of Q in the open-circuit condition is 35. When the RL damping circuit is present, Q (during ring-down) drops to about 5.

Moreover, the use of the inductor-resistor network does in fact improve the TPaD's ability to generate net force at the fingertip. For purposes of illustration, in a TPaD prototype having the RL circuit, the improvement in average finger force was 31% at the out-of-plane frequency used (39 kHz).

The inductor-resistor network thus is capable of significantly decreasing the decay time (by decreasing Q). However, when low friction is requested, the need for high amplitude oscillations dictates the need for a high-Q TPaD. If the LR network is always present, it will absorb energy from the voltage source and the peizo, increasing energy consumption and reducing the amplitude of the TPaD oscillation at all times during the shiver cycle.

It is possible to actively adjust the Q of the system by switching the LR network in and out of the main control circuit of the piezoelectric element. To be beneficial, the switching operation must be completed very quickly (on the order of about 100 μs). A solid state relay chip (IR PVR33N from International Rectifier) was chosen to achieve fast switching times, handle bipolar supply voltages, and provide optical isolation. FIG. 7 shows the simple circuit used to switch the LR network in and out of the main control circuit using the solid state relay chip.

The control PIC is used to control the state of the two relays within in the IRPVR33N solid state relay chip. When the upper relay is closed, the piezo is being actuated by the AC supply and the lower relay is opened to prevent the LR network from absorbing energy. When the upper relay is open, the lower relay is closed to introduce the RL network in the main control circuit and damp out the TPaD's vibrations.

FIG. 9 shows another illustrative embodiment of the invention wherein the electrical damping circuit comprises an active feedback circuit comprising a sensing piezoelectric element 201 affixed to the haptic device TPaD to measure vibration amplitude. For example, the sensing piezoelectric element 201 can be affixed by adhesive to the opposite side of the haptic device from the side to which the piezoelectric actuator 102 is affixed, see FIG. 4. The output signal (e.g. voltage) of the sensing piezoelectric element 201 is measured and fed back to a comparator 202 where it is subtracted from the output of the PIC, which is normally zero when damping is desired. The output of comparator 202 is then input to a feedback controller 204 that outputs a modulated drive (damping) command signal to the piezoelectric actuator 102, which command signal is based on a proportional, proportional plus derivative, or proportional plus integral plus derivative signal processing, all of which are well known in the feedback signal processing art. When damping of out-of-plane oscillations of the substrate 100 is required, the PIC tells the feedback controller 204 to output the damping command signal to the piezoelectric actuator 102 to damp out out-of-plane oscillations between low and high friction states of the touch surface 104, thereby reducing the transition time (decay time) between the low and high friction states. The feedback controller 204 can be implemented in analog due to the high frequencies involved, but may be implemented in digital with a fast enough processor, such as a digital signal processor (DSP) or field programmable gate array (FPGA). A feedback circuit can be provided for each of multiple out-of-plane vibration modes if present.

Embodiments of the invention described allow computer (software)-controlled haptic effects to be displayed on the glass plate substrate surface, including not only variable friction but also lateral forces that actively push the finger or object across the surface. Stronger haptic effects are possible. An additional use is also possible, not as a haptic display but instead as a mechanism for driving objects around a surface under computer control, as might be useful in parts feeding or similar applications in robotics or manufacturing.

In the above-described embodiments, the haptic device TPaD is ultrasonically vibrated for the friction reduction effect as one unit. As an alternative embodiment, more than one ultrasonic actuator can be used so that different areas of the glass plate surface have different ultrasonic amplitudes, perhaps each modulated to correspond to different phases of the in-plane vibrating or swirling motion. Another way to attain spatial variation of ultrasonic amplitude across the glass plate surface, is to make use of the nodal patterns of ultrasonic vibration (see copending U.S. application Ser. No. 12/383,120 filed Mar. 19, 2009, or to combine this with more than one ultrasonic frequency, or with ultrasonic actuators driven with different phases.

It should be appreciated that the present invention is not limited to planar substrate surfaces. For example, the finger forces could be generated at the surface of a cylindrical knob by creating ultrasonic vibrations in the radial direction, and “lateral” oscillations in the axial and/or circumferential directions. Indeed, any surface will have a surface normal and two axes that lie in the surface, at least locally. Ultrasonic vibration along the normal and lower frequency vibration along one or two in-surface axes can be coordinated to generate traction forces.

There is no reason that the lateral or out-of-plane oscillations need to be persistent. In many applications, it is necessary to apply active traction forces for brief instants only. In such cases, the lateral oscillations can be turned off until they are needed to generate the traction force. Indeed for some haptic effects only a single cycle or even only a half-cycle of a lateral oscillation may suffice. The amplitude or number of lateral oscillations may be selected to be sufficient to move the user's finger a desired distance, or to apply a force to it for a desired duration, and then the lateral oscillations may be discontinued.

Although the invention as been described with respect to certain illustrative embodiments thereof, those skilled in the art will appreciate that changes and modifications can be made thereto within the scope of the invention as set forth in the pending claims.

References, which are incorporated herein by reference;
[1] M. Biet, F. Giraud, and B. Lemaire-Semail. Implementation of tactile feedback by modifying the perceived friction. European Physical Journal Appl. Phys., 43:123135, 2008.
[2] S. M. Biggs, S. Haptic Interfaces, chapter 5, pages 93-115. Published by Lawrence Erlbaum Associates, 2002.
[3] M. Minsky. Computational Haptics: The Sandpaper System for Synthesizing texture for a force-feedback display. PhD thesis, Massachusetts Institute of Technology, Cambridge, Mass., 1995.
[4] J. Pasquero and V. Hayward. Stress: A practical tactile display with one millimeter spatial resolution and 700 hz refresh rate. Dublin, Ireland, July 2003.
[5] G. Robles-De-La-Torre. Comparing the Role of Lateral Force During Active and Passive Touch: Lateral Force and its Correlates are Inherently Ambiguous Cues for Shape Perception under Passive Touch Conditions. pages 159-164, 2002.
[6] G. Robles-De-La-Torre and V. Hayward. Force can overcome object geometry in the perception of shape through active touch. Nature, 412:445-448, July 2001.
[7] M. Takasaki, H. Kotani, T. Mizuno, and T. Nara. Transparent surface acoustic wave tactile display. Intelligent Robots and Systems, 2005. (IROS 2005). 2005 IEEE/RSJ International Conference on, pages 3354-3359, August 2005.
[8] V. Vincent Levesque and V. Hayward. Experimental evidence of lateral skin strain during tactile exploration. In Proc. of Eurohaptics, Dublin, Ireland, July 2003.
[9] T. Watanabe and S. Fukui. A method for controlling tactile sensation of surface roughness using ultrasonic vibration. Robotics and Automation, 1995. Proceedings., 1995 IEEE International Conference on, 1:1134-1139 vol. 1, May 1995.
[10] L. Winfield, J. Glassmire, J. E. Colgate, and M. Peshkin. T-pad: Tactile pattern display through variable friction reduction. World Haptics Conference, pages 421-426, 2007.
[11] A. Yamamoto, T. Ishii, and T. Higuchi. Electrostatic tactile display for presenting surface roughness sensation. pages 680-684, December 2003.
[12] E. C. Chubb, “ShiverPaD: A Haptic Surface Capable of Applying Shear Forces to the Bare Finger,” Master's Thesis, Department of Mechanical Engineering, Northwestern University, December 2009.
[13] S.-C. Kim, T.-H. Yang, B.-K. Han, and D.-S. Kwon, “Interaction with a display panel—an evaluation of surface-transmitted haptic feedback,” in International Conference on Control, Automation and Systems, October 2008.
[14] Y. Kato, T. Sekitani, M. Takamiya, M. Doi, K. Asaka, T. Sakurai, and T. Someya, “Sheet-type braille displays by integrating organic field-effect transistors and polymeric actuators,” Electron Devices, IEEE Transactions on, vol. 54, no. 2, pp. 202-209, February 2007. Den Hartog
[15] D. Wang, K. Tuer, M. Rossi, and J. Shu, “Haptic overlay device for flat panel touch displays,” in Symposium on Haptic Interfaces for Virtual Environment and Teleoperator Systems, 2004.
[16] D. Wang, M. Rossi, K. Tuer, and D. Madill, “Method and system for providing haptic effects,” United States Patent Application Publication, no. 20060209037, September 2006.
[17]S. O. R. Moheimani, “A survey of recent innovations in vibration damping and control using shunted piezoelectric transducers,” IEEE Transactions on Control Systems Technology, vol. 11, pp. 482-494, 2003.
[18] J. P. D. Hartog, Mechanical Vibrations, 4th ed. McGraw-Hill, 1956

1. A haptic device comprising a substrate having a touch surface, at least one first actuator for subjecting the substrate to friction reducing ultrasonic oscillations controlled to provide relatively low and high friction states of the touch surface, at least one second actuator for subjecting the substrate to lateral oscillations while the substrate is alternated between the low and high friction states in a manner to generate a force felt by a user's finger on the touch surface, a control device for providing signals to the at least one first actuator to establish relatively low and high friction states of the touch surface, and at least one electrical damping circuit for reducing the transition time between the low and high friction states.

2. The device of claim 1 wherein the at least one electrical damping circuit comprises a resistor-inductor circuit between the control device and the at least one first actuator for damping out-of-plane oscillations of the substrate.

3. The device of claim 2 wherein the at least one resistor-inductor circuit is disposed in parallel between electrical conductors between the control device and the at least one first actuator.

4. The device of claim 1 including a relay between the control device and the at least one first actuator for connecting the at least one electrical damping device to a control circuit to reduce said transition time when the at least one first actuator is de-energized and for disconnecting the at least one electrical damping device when the at least one first actuator is energized.

5. The device of claim 4 wherein the relay is controlled by a microcontroller or application-specific integrated circuit that actuates/deactuates the control device.

6. The device of claim 1 wherein the electrical damping circuit comprises a sensing piezoelectric element on the substrate and whose output is sent to a feedback controller, which outputs a damping command to the at least one first actuator when out-of-plane oscillations are to be damped.

7. The device of claim 1 wherein the at least one first actuator is a piezoelectric vibrator for imparting out-of-plane oscillations.

8. The device of claim 1 which is controlled to provide a force on the user's finger wherein the force has non-zero average and in which the non-zero average force is sustained by controlled substrate oscillations

9. A haptic device comprising a flat substrate having a touch surface, a flat piezoelectric actuator laminated to the flat substrate for subjecting the substrate to friction reducing, out-of-plane ultrasonic oscillations to provide a relatively low friction state when the piezoelectric actuator is energized wherein the substrate is in a relatively high friction state when the piezoelectric actuator is not energized, another actuator for subjecting the substrate to in-plane lateral oscillations while the substrate is alternated between the low and high friction states in a manner to generate a force felt by a user's finger on the touch surface, a control device for providing signals to the piezoelectric actuator to energize it to out-of-plane ultrasonically oscillate the substrate to provide the relatively low friction state, a resistor-inductor damping circuit in parallel between electrical conductors between the control device and the piezoelectric actuator for damping unforced out-of-plane oscillations and reduce the transition time between the low and high friction states, and a solid state relay between the control device and the piezoelectric actuator for connecting the resistor-inductor damping circuit to reduce said transition time when the piezoelectric actuator is de-energized and for disconnecting the resistor-inductor damping circuit when the piezoelectric actuator is energized.

10. A method of controlling a haptic device having a substrate with a touch surface, comprising subjecting the substrate to out-of-plane ultrasonic oscillations controlled to provide low and high friction states of the touch surface, subjecting the substrate to lateral in-plane oscillations while the substrate is alternated between the low and high friction states in a manner to generate a force felt by a user's finger on the touch surface, and electrically damping unforced substrate friction-reducing oscillations to reduce the transition time between the low and high friction states.

11. The method of claim 10 wherein electrical damping is effected by a resistor-inductor damping circuit.

12. The method of claim 11 including rendering the resistor-inductor circuit operative only when the friction-reducing ultrasonic oscillations are terminated.

13. The method of claim 10 wherein electrical damping is effected by a feedback circuit.

14. The method of claim 10 wherein reducing of the transition time increases forces felt by a user's finger on the touch surface.

15. The method of claim 10 including controlling substrate oscillations to provide a force on the user's finger wherein the force has non-zero average and in which the non-zero average force is sustained by substrate oscillations.
